(19) United States
(12) Patent Application Publication
(10) Pub. No.: US 2022/0048217 A1
(43) Pub. Date: Feb. 17, 2022

(54) MACHINE AND METHOD FOR COMPACTING A POWDER MATERIAL

(71) Applicant: SACMI COOPERATIVA MECCANICI IMOLA SOCIETA' COOPERATIVA, Imola (IT)

(72) Inventors: Stefano SCARDOVI, Imola (IT); Luigi OSSANI, Imola (IT)

(21) Appl. No.: 17/274,381

(22) PCT Filed: Sep. 6, 2019
(86) PCT No.: PCT/IB2019/057534

§ 371 Date: Mar. 8, 2021

(30) Foreign Application Priority Data
Sep. 7, 2018 (IB) PCT/IB2018/056840
Sep. 7, 2018 (IT) 102018000008417

(51) Int. Cl. B28B 13/02; B28B 17/00; B28B 3/12; B30B 15/30; B30B 5/06

(52) U.S. Cl. CPC B28B 13/022; B28B 17/0081; B30B 5/06; B30B 15/308; B28B 3/123

(57) ABSTRACT

Machine and method for compacting a powder material; the machine comprises a compacting device, which is designed to compact the powder material; a conveyor assembly to transport the powder material along a first portion of a given path to the compacting device; and a feeding assembly, which is designed to feed the powder material to the conveyor assembly and comprises a transfer chamber designed to hold and transfer the powder material; movable elements are present at a wall of the transfer chamber.

### CROSS-REFERENCE TO RELATED APPLICATIONS

This patent application claims priority from Italian patent application no. 102018000008417 and International application no. PCT/IB2018/056840 filed on Sep. 7, 2018 the entire disclosure of which is incorporated herein by reference.

### TECHNICAL FIELD

The present invention relates to a method and a machine for compacting a powder material comprising ceramic powder. The present invention also relates to a plant for the production of ceramic articles.

### BACKGROUND OF THE INVENTION

In the field of production of ceramic articles (in particular, slabs; more particularly, tiles) it is known to use semi-dry powder compacting machines (ceramic powders; typically with a moisture content of about 5-6%). These machines include ceramic powder feeding devices of different types.

Often these machines are used to make products that mimic natural stones, such as marble and/or granite. These products have internal grains distributed randomly within the thickness of the products.

Alternatively or additionally, it may be appropriate to use powders of different types to obtain items with particular structural and/or physical characteristics.

In some cases, mixtures of powders of different colours are brought with a random distribution inside cavities of steel moulds and then compressed so as to obtain, e.g. sheets of compacted powder.

It has been proposed to produce slabs with a random distribution of powders of different colours also using continuous compacting machines, which comprise a conveyor assembly for transporting (in a substantially continuous way) the powder material along a given path from an inlet station to a working station, at which a compacting device is arranged, which is able, by means of the cooperation of pressure rollers, to compact the powder material so as to obtain a layer of compacted powder. A feeding assembly brings the powder material to the conveyor assembly at the inlet station.

An example of a continuous machine for compacting ceramic powder is described in the international patent application with publication number WO2005/068146 of the same applicant as the present application.

It is also known to manufacture (e.g. by digital printing) a graphic decoration over the layer of compacted ceramic powder in order to make the finished article visually more similar to a natural product.

However, the systems available up to now for compacting ceramic powders have several drawbacks, among which there are the following.

The feeding of the powder material by means of the feeding assembly is not always easy, e.g. it sometimes occurs a formation of agglomerates and/or clogging. This negatively affects both the structural quality of the final product and the productivity (e.g., sometimes it is necessary to interrupt the production to unclog the clogging).

The powder distribution is modified in an uncontrolled way during the transport to the conveyor assembly by means of the feeding assembly.

Very rarely the veins that are made in the thickness of the articles (and that therefore are visible when looking at the edge of the articles) are coordinated with respect to the surface decorations obtained by printing.

The aesthetics of the product are significantly affected by the above, making much more evident the difference if compared to a natural product such as marble.

CN101549522 discloses a machine for compressing ceramic powder, said machine comprising a powder feeding device provided with a feeding channel provided with a belt. According to one of the embodiments described therein (FIG. 2), the channel is movable between a substantially vertical orientation (shown in FIG. 2) to a substantially horizontal orientation (not shown). The end of the channel is provided with a belt conveyor, which is rotated in an integral manner with the channel so as to be oriented vertically when the channel is loaded with the powder and to be oriented horizontally after the channel has been completely loaded.

The object of the present invention is to provide a machine and a method for compacting powder material and a plant and a method for the production of ceramic articles, which allow overcoming, at least partially, the drawbacks of the known art and are, at the same time, easy and inexpensive to manufacture.

### SUMMARY

According to the present invention, a machine and a method for compacting powder material and a plant for producing ceramic articles are provided according to what is stated in the following independent claims and, preferably, in any of the claims depending directly or indirectly on the independent claims.

### BRIEF DESCRIPTION OF THE FIGURES

The invention is described below with reference to the annexed drawings showing some non-limiting exemplary embodiments, in which:

FIG. 1 is a schematic side view of a plant in accordance with the present invention;

FIG. 2 is a schematic side view of a detail of a machine of the plant of FIG. 1 on an enlarged scale;

FIG. 3 is a schematic side view of an alternative embodiment of the detail of FIG. 2;

FIG. 4 shows the detail of FIG. 3 in a different operative configuration;

FIG. 5 is a front view (with parts removed for clarity's sake) of a detail of the machine of the plant of FIG. 1;

FIG. 6 shows on an enlarged scale a section along the line VI-VI of FIG. 5;

FIG. 7 is a rear view of a part of FIG. 5;

FIG. 8 is a schematic perspective view of a part of the plant of FIG. 1;

FIG. 9 is a virtual representation of a part of the plant control procedure of FIG. 1;

FIG. 10 is a side view, partially in section and on an enlarged scale, of a detail of the plant of FIG. 9; and

FIG. 11 is a schematic front view of a detail of FIG. 2.

### DETAILED DESCRIPTION

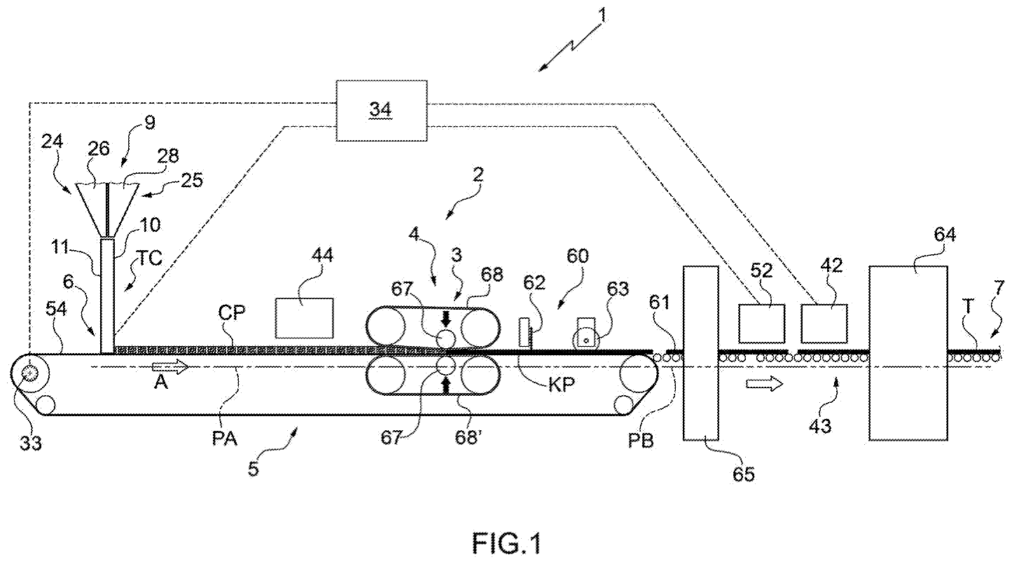

In FIG. 1 the reference number 1 indicates as a whole a plant for making ceramic articles T. The plant 1 is provided with a compacting machine 2 for compacting the powder material CP, comprising ceramic powder. In particular, the powder material CP is ceramic powder, e.g. containing clays, sands and/or feldspars.

In particular, the ceramic articles T produced are slabs, more precisely, tiles.

The machine 2 comprises a compacting device 3, which is arranged at a working station 4 and is designed to compact the powder material CP so as to obtain a layer of compacted powder KP. It further comprises a conveyor assembly 5 for transporting in a substantially continuous way the powder material CP along a portion PA of a given path in an advancing direction A from an inlet station 6 to the working station 4 and the layer of compacted powder KP, in particular in the direction A, from the working station 4 along a portion PB of the given path, in particular to an outlet station 7. In particular, the given path consists of the portions PA and PB.

The machine 2 is further provided with a feeding assembly 9, which is designed to feed the ceramic powder CP to the conveyor assembly 5 at the inlet station 6.

In particular, the feeding assembly 9 is designed to feed the ceramic powder to the conveyor assembly 5 in a substantially continuous manner.

In particular, the conveyor assembly 5 is also designed to hold the powder material CP and the compacted powder material KP from below.

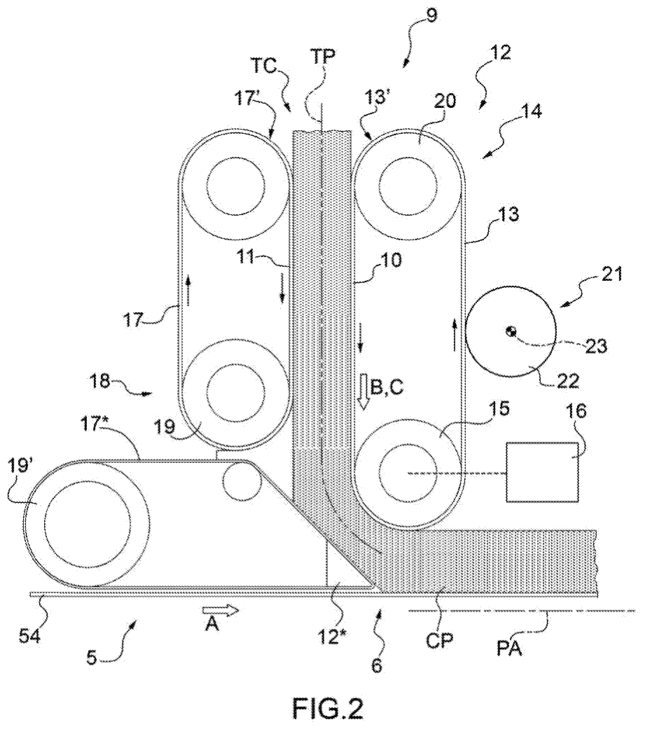

With particular reference to FIGS. 2, 3 and 4, the feeding assembly 9 comprises a transfer chamber TC designed to hold and transfer the powder material CP, in particular along a transfer path TP. In particular, mainly in a transfer direction B crosswise to the advancing direction A.

According to some non-limiting embodiments, the transfer chamber TC is designed to transfer the powder material CP mainly in the direction B substantially perpendicular to the direction A.

More precisely, the transfer chamber TC is designed to transfer the powder material CP on the conveyor assembly 5. Even more precisely, the transfer chamber TC has an open end arranged at the inlet station 6 and at the conveyor assembly 5.

The transfer chamber TC has at least one wall 10, which is crosswise, more precisely, perpendicular, to the advancing direction A.

According to some non-limiting embodiments such as the one shown in FIG. 2, the wall 10 is substantially parallel, or has at least a substantially parallel portion, to the transfer direction B.

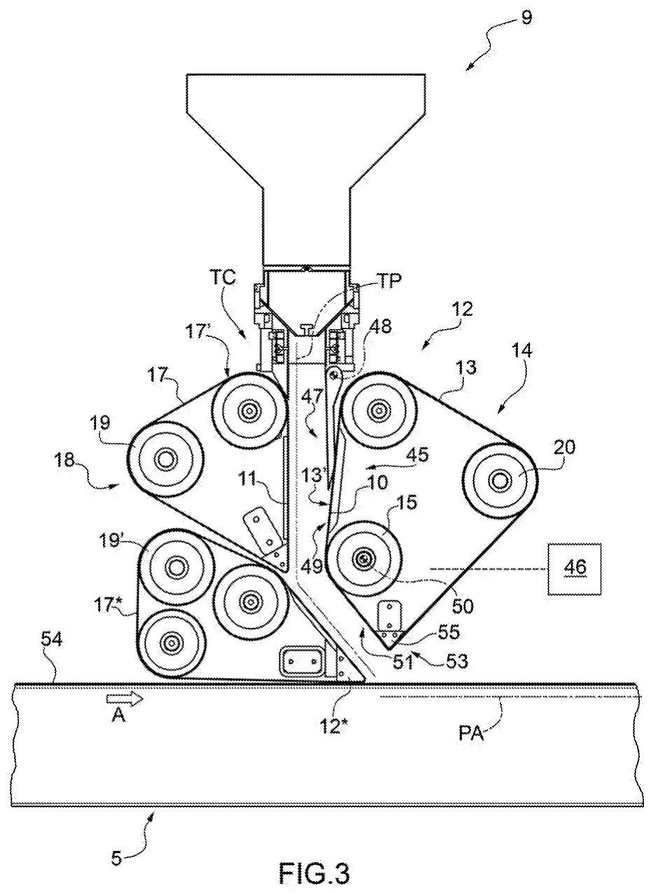

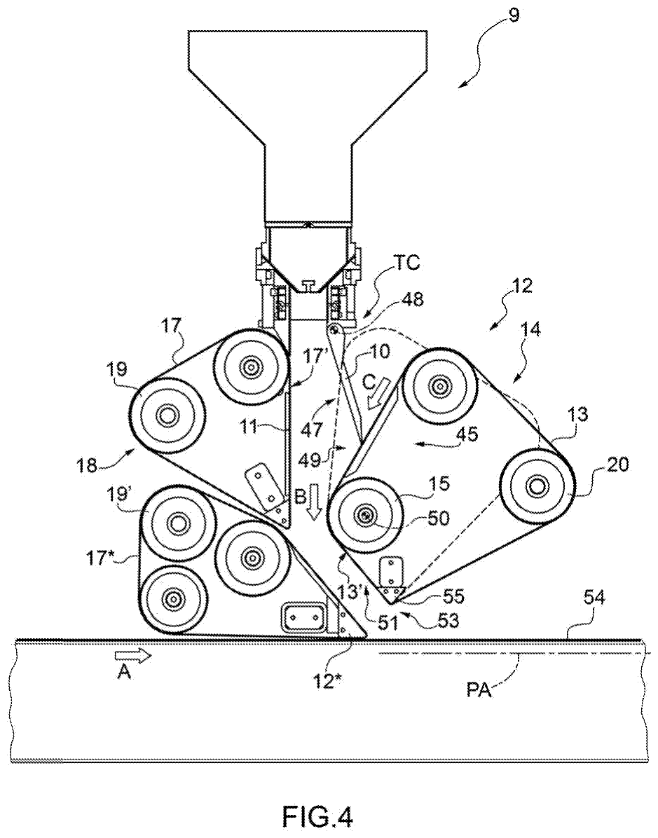

As an alternative (see, e.g., FIGS. 3 and 4), the wall 10 is slightly inclined with respect to the direction B.

In particular, the transfer chamber TC has at least one further wall 11 crosswise, more precisely perpendicular, to the advancing direction A. More specifically, the wall 11 faces the wall 10. Even more particularly, the walls 10 and 11 are arranged in succession in the direction A, i.e. the wall 10 is arranged downstream of the wall 11.

According to some non-limiting embodiments, at least one of the wall 10 and the wall 11, in particular the wall 11, is substantially perpendicular to the advancing direction A.

In some non-limiting cases, the walls 10 and 11 are (FIG. 2) substantially parallel to each other or have respective substantially parallel portions (see FIGS. 3 and 4).

According to some non-limiting embodiments, the transfer chamber TC also has side walls, laterally delimiting the transfer chamber TC, crosswise to (perpendicular) and connecting the walls 10 and 11. In particular, the side walls are substantially parallel to the direction A.

Advantageously but not necessarily, the feeding assembly 9, and in particular the transfer chamber TC, comprises at least one advancing assembly 12, which comprises at least one movable surface 13′ arranged at the wall 10 and a moving device 14 (schematically shown in FIGS. 2 to 4) to move (in particular, by sliding it) the movable surface 13′ crosswise to the direction A towards the conveyor assembly 5, in particular, along at least a first given portion of the transfer path TP; more specifically, in the direction B.

More precisely, the advancing assembly 12 comprises at least one belt 13 arranged at least partially at the wall 10 and the moving device 14 (schematically shown in FIG. 2) to move the belt 13 (in particular, by sliding it) crosswise to the direction A towards the conveyor assembly 5, in particular along at least a first portion of the transfer path TP; more particularly, in the direction B. In particular, the surface 13′ is the inner surface, facing the inside of the transfer chamber TC of the belt 13.

More precisely, the moving device 14 is designed to move the belt 13 in a moving direction C, crosswise to the advancing direction A.

In the embodiment of FIG. 2, the direction B and the direction C are substantially coincident. In the embodiment of FIG. 4, the direction B and the direction C are crosswise to each other.

In particular, the belt 13 is moved (by sliding) along a closed path defined by the extension of the belt 13, whose portion coincides with a portion of the transfer path TP.

Thanks to the advancing assembly 12, it is surprisingly possible to facilitate the passage of the powder material CP along the transfer chamber TC. Moreover, it has been observed that, when powder materials of different types are used, such powder materials are more difficult to be mixed together (their distribution is not substantially altered) having a greater tendency to maintain their relative position.

More precisely, the moving device 14 comprises at least one motor-driven pulley 15, that is to say connected directly or via a kinematic mechanism to a drive 16 of the moving device 14. In particular, the belt 13 is at least partially wound about the pulley 15. More precisely, but not necessarily, the drive 16, e.g. an electric motor, is designed to rotate the pulley 15 about an axis thereof, which is crosswise, in particular perpendicular to the direction A and, more particularly, to the direction B.

According to some non-limiting embodiments, the advancing assembly 12, and more precisely the moving device 14, comprises a plurality of (in the embodiment of FIG. 2, two) pulleys (including the pulley 15) about which the belt 13 is wound.

In particular, the belt 13 defines at least one portion of the wall 10.

According to some non-limiting embodiments, the belt 13 comprises, in particular, consists of, a polymeric material, e.g. polyurethane.

Advantageously but not necessarily, the advancing assembly 12 comprises at least one movable surface 17′ arranged at the wall 11 and a moving device 18 to move the movable surface 17′ crosswise to the direction A towards the conveyor assembly 5, in particular, along at least one respective second given portion of the transfer path TP; more particularly, in the direction B. In particular, the first given portion and the second given portion of the transfer path TP are at least partially coincident.

More precisely, the advancing assembly 12 comprises at least one further belt 17 arranged at least partially at the wall 11 and a moving device 18 to move the belt 17 crosswise to the direction A (in particular, towards the conveyor assembly 5). In particular, the belt 17 defines at least one portion of the wall 11. In particular, the surface 17′ is the inner surface of the belt 17, facing the inside of the transfer chamber TC.

Advantageously but not necessarily, the moving device 18 designed to move (and, in use, moves) the movable surface 17′, more precisely the belt 17, at a speed substantially equal to the speed at which the moving device 14 is designed to move (and, in use, moves) the movable surface 13′, more precisely the belt 13.

According to some non-limiting embodiments, the moving device 18 comprises at least one motor-driven pulley 19, i.e. it is connected, directly or via a kinematic mechanism, to a drive, e.g. the drive 16. In particular, the belt 13 is at least partially wound about the pulley 19. More precisely, the drive is designed to rotate the pulley 19 about an axis thereof, which is crosswise, in particular perpendicular, to the directions A and B. In particular, the axis of rotation of the pulley 19 is substantially parallel to the axis of rotation of the pulley 15.

According to some non-limiting embodiments, the advancing assembly 12, and more precisely the moving device 18, comprises a plurality of pulleys, including the pulley 19, about which the belt 17 is wound. In some non-limiting embodiments, one of such pulleys is a tensioner pulley.

With particular reference to FIGS. 3 and 4, according to some non-limiting embodiments, the advancing assembly 12 comprises a further belt 17* arranged between the belt 17 and the conveyor assembly 5. In particular, also the belt 17* is moved by a respective motor-driven pulley 19′.

In particular, the belt 17* defines a portion of the wall 11 crosswise to the direction A (and, in particular, to the direction C). More particularly, in this way, the powder material CP gradually passes from being mainly conveyed along the direction B to be conveyed along the direction A.

In this way, the transfer of the powder material CP on the conveyor assembly 5 is made easier.

According to some non-limiting embodiments, the portion of the wall 11 defined by the belt 17* is inclined with respect to the direction A by an angle facing upwards and towards the working station comprised between 100° and 170°.

According to some non-limiting embodiments, the advancing assembly 12 comprises a transmission element (tile) 12*, in particular having a pointed shape; more particularly with a substantially triangular section, about which the belt 17 is partially wound, and on which, in use, the tape 17* slides.

More precisely, the transmission element 12* is arranged at the inlet station 6, at one end of the portion PA.

Advantageously but not necessarily, with particular reference to FIGS. 3 and 4, at least one of the pulleys (e.g. the pulley 20) of the moving device 14 is a tensioner pulley. As will be better understood in the remainder of the text, this aspect becomes particularly relevant when one or more pulleys are moved.

Advantageously but not necessarily, the moving device 14 comprises (FIGS. 2 and 11) an adjusting assembly 21 for adjusting the crosswise position of the belt 13 with respect to the longitudinal extension of the belt 13.

In this way, it has been experimentally observed that the quality (aesthetic and not only) of the final products is improved. It has been assumed that this is due to various factors, including the reduction of agglomerates and/or clogging and, where there are several types of powder, to a more precise maintenance of the relative distribution of the different types of powder.

It has also been experimentally observed that among other things this even reduces any possible malfunctioning and, therefore, any clogging and/or slowing down of the feeding assembly 9.

In particular, the adjusting assembly 21 is designed to detect the crosswise position of the belt 13 and to move the belt 13 crosswise (with respect to the longitudinal extension of the belt 13).

The adjusting assembly 21 is particularly useful since, typically, the belt 13 is relatively wide (even two m wide) and short.

More particularly, the adjusting assembly 21 comprises one or more sensors, e.g. proximity sensors, known per se and not shown, to detect the position of one of the longitudinal edges of the belt 13. Even more particularly, said sensor(s) is/are arranged at the aforementioned edge.

According to some non-limiting embodiments, the adjusting assembly 21 comprises an adjusting roller 22, which is in contact with the belt 13 and has a respective axis of rotation 23 and a positioning device (known per se and not shown) to rotate the roller 22 so that the axis of rotation 23 changes its orientation, in particular, with respect to the longitudinal extension of the belt 13, in addition to or as an alternative with respect to the direction C; in addition to or as an alternative with respect to the direction A; in addition to or as an alternative to the axis of rotation of the pulley 15. By modifying the orientation of the axis of rotation 23, it is possible to move crosswise the belt 13, which slides partially on the roller 22.

The positioning device is designed to rotate the adjusting roller 22 so that the axis of rotation 23 changes its orientation with respect to the direction C and to the axis of rotation of the pulley 15.

According to some non-limiting and not shown embodiments, the moving device 18 comprises an adjusting assembly for adjusting the crosswise position of the belt 17 with respect to the longitudinal extension of the belt 17. This adjusting assembly is defined as indicated above with regard to the adjusting assembly 21.

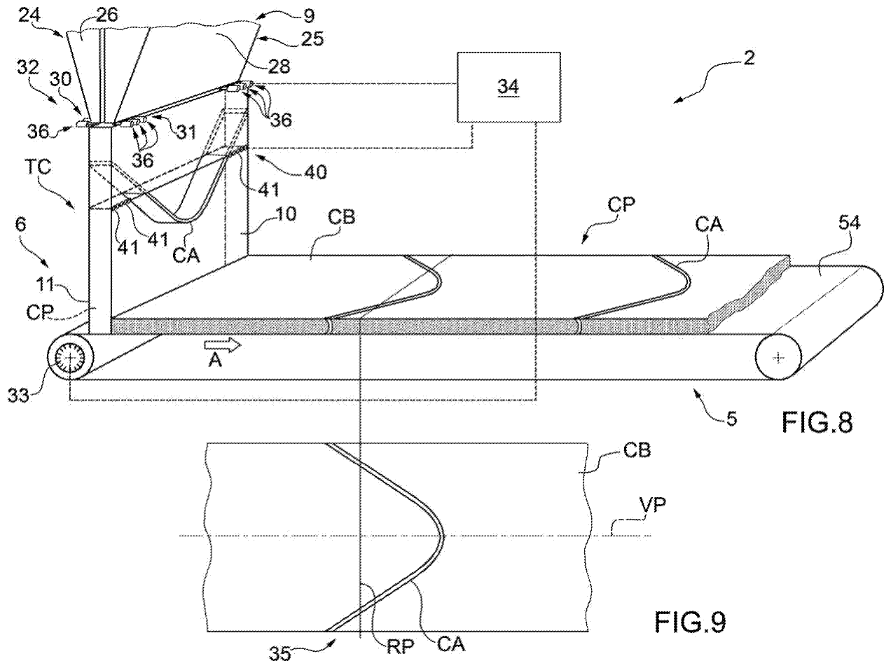

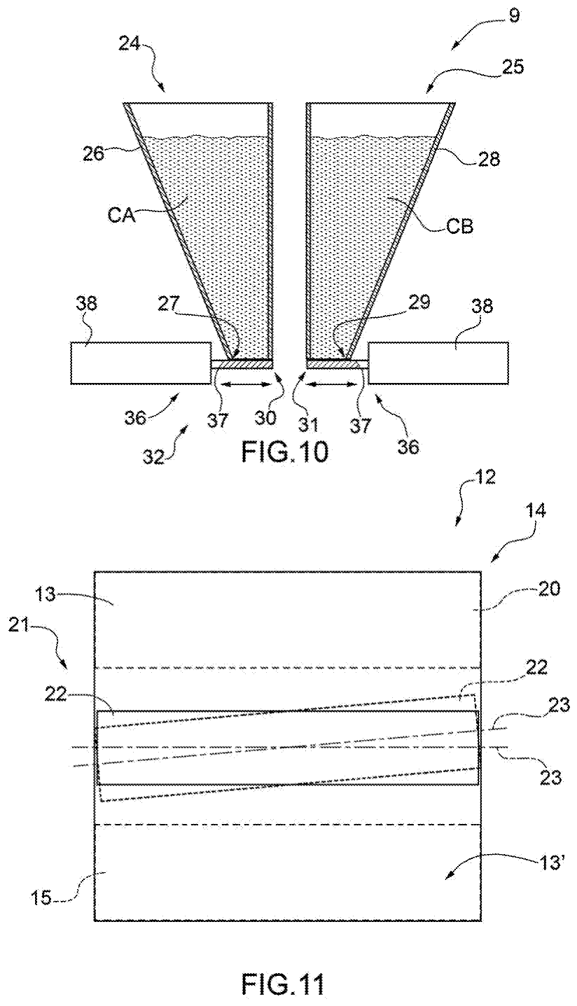

Advantageously but not necessarily, the feeding assembly 9 comprises (see in particular FIGS. 8 and 10) a feeding device 24 and a feeding device 25 arranged above the conveyor assembly 5 and the transfer chamber TC.

The feeding device 24 is designed to hold and feed a ceramic powder material CA of a first type.

More precisely, the feeding device 24 comprises a respective containment chamber 26 (see in particular FIG. 4) having a relative outlet mouth 27, whose longitudinal extension is crosswise (in particular, perpendicular) to the advancing direction A.

The feeding device 25 is designed to hold and feed a ceramic powder material CB of a second type.

More precisely, the feeding device 25 comprises a respective containment chamber 28 having a relative outlet mouth 29, whose longitudinal extension is crosswise, in particular perpendicular, to the advancing direction A.

In particular, the longitudinal extensions of the outlet mouths 27 and 29 are substantially parallel to each other.

In particular, the containment chamber 26 is designed to contain the powder material CA and the containment chamber 28 is designed to contain the powder material CB, which is different from the powder material CA.

In particular, the powder material CP consists of one or both of the powder materials CA and CB. More precisely, the powder material CP comprises (consists of) the powder materials CA and CB.

According to some non-limiting embodiments, the powder materials CA and CB are ceramic and have different colours. In this way it is possible to create chromatic effects in the thickness of ceramic articles T. Such chromatic effects are e.g. visible in the edges of the ceramic articles. Alternatively or additionally, the powder materials CA and CB are designed to provide different physical characteristics to the ceramic articles T.

Please note that the presence of the transfer chamber TC is particularly advantageous in the cases in which the feeding assembly 9 comprises the feeding devices 24 and 25. In these cases, in fact, it has been experimentally observed that the deformation of the distribution of the powders CA and CB as they pass through the transfer chamber TC is reduced. With particular reference to FIG. 8, it is reduced the deformation of the stripe of powder material CA in the thickness of the powder material CP arranged on the conveyor assembly 5.

According to some non-limiting embodiments, the outlet mouth 27 has respective passage areas 30 (see, in particular, FIGS. 8 and 10) arranged in succession along the longitudinal extension of the outlet mouth 27. The outlet mouth 29 has respective passage areas 31 arranged in succession along the longitudinal extension of the outlet mouth 29.

Advantageously but not necessarily, the feeding assembly 9 comprises an operating device 32, which is designed to selectively regulate the passage of the powder material from the feeding device 24 and from the feeding device 25 to the transfer chamber TC.

In particular, the operating device 32 is designed to allow the selective exit of the powder material through one or more of the passage areas 30 and 31. In particular, each passage area 30 is arranged next to (more precisely, faces; in particular, is associated with) a respective passage area 31.

According to some non-limiting embodiments, the machine further comprises (FIGS. 1 and 8) a detection device 33, e.g. an encoder, for detecting how long the conveyor assembly 5 transports the powder material CP along the given path in the advancing direction A, in particular, along the portion PA, and a control unit 34, which is designed to store (has stored) a reference distribution 35 (FIG. 9) of the powder material CA and CB of the desired first and second types in the powder material CP conveyed by the conveyor assembly 5 and to control the operating device 32 according to what has been detected by the detection device 33 as well as according to the reference distribution 35. More in particular, the control unit 34 is designed to control the operating device 32 according to what has been detected by the detection device 33 so as to reproduce the reference distribution 35 on the conveyor assembly 5.

According to some non-limiting embodiments (see, in particular, FIGS. 8 and 10), the operating device 32 comprises a plurality of drive units 36, only some of which are shown in FIG. 8, each of which is arranged at a respective passage area 30 and/or 31 and is designed to regulate the passage of the powder material through the respective passage area 30 and/or 31.

In this way, it is possible to obtain at any time a punctual mixture of powder materials CA and CB.

In particular, the drive units 36 are arranged in succession in a crosswise direction, in particular perpendicular to the advancing direction A, along the longitudinal extension of the outlet mouth 27 and/or 29.

Advantageously but not necessarily, each drive unit 36 comprises at least one respective shutter 37 and a respective actuator 38, e.g. an electric actuator, designed to move substantially horizontally the shutter 37 between a locking position (shown in FIG. 10), in which the shutter prevents the passage of powder material through the respective passage area 30 and/or 31, and an open position (not shown), in which the shutter 37 at least partially does not prevent the passage of powder material through the respective passage area 30 and/or 31.

According to some non-limiting embodiments (such as the one shown in FIGS. 8 and 10) the operating device 32 comprises two groups (rows) of drive units 36, each of which groups (rows) is associated with one of the containment chambers 26 and 28. Each drive unit 36 is designed to regulate the passage of the powder material through a respective passage area 30 or 31, but not through both.

Advantageously but not necessarily, the control unit 34 comprises a memory storing the reference distribution 35 (FIG. 9). The control unit 34 is designed to advance the reference distribution 35 along a virtual path VP through a virtual reference front RP based on what has been detected by the detection device 33. More specifically, the control unit 34 is designed to advance the reference distribution 35 along the virtual path VP through a virtual reference front RP having the length detected by the detection device 33.

The virtual reference front RP has a plurality of positions, each of which corresponds to a passage area 30 and to a passage area 31 adjacent to each other. The control unit 34 is designed to allow the outlet of the powder material CA and/or CB at a specific time through the passage areas 30 and/or 31 according to the type of powder material CA and/or CB provided in the specific moment, in the reference distribution 35, in the positions of the virtual reference front RP corresponding to said passage areas 30 and/or 31.

In other words, the control unit 34 is designed to allow the powder material CA and/or CB to leave at a specific time through each passage area 30 and/or 31 according to the type of powder material that is provided for each given position at the intersection of the virtual reference front RP with the reference distribution 35 at that specific time.

More precisely, e.g. if in a specific moment the virtual reference front RP intersects in a given position an area of the reference distribution 35 provided with the powder material CA of the first type, the passage area 30, which corresponds to the given position, will be (kept) open, whereas the passage area 31, which corresponds to the given position, will be (kept) closed.

Advantageously but not necessarily, the transfer chamber TC is arranged between the feeding devices 24 and 25 on one side and the conveyor assembly 5 on the other. In particular, the transfer chamber TC is arranged below the feeding devices 24 and 25 and above the conveyor assembly 5.

This allows compensating for any temporary discontinuities in feeding the powder material.

Advantageously but not necessarily, the compacting machine 2 comprises a detection device 40, which is designed to detect the level of powder material inside the transfer chamber TC. The control unit 34 is designed to operate the operating device 32 according to the level of powder material CP detected inside the transfer chamber TC. In particular, the control unit 34 is designed to operate the operating device 32 so as to maintain the level of the powder material CP inside the transfer chamber TC below a maximum level (and above a minimum level). More precisely, the control unit 34 is designed to operate the operating device 32 so as to activate the feeding of powder material to the transfer chamber TC when, in use, the amount of powder material is below a first reference level and to stop the feeding of powder material into the transfer chamber TC when, in use, the amount of powder material is above a second reference level. In some cases, the first and the second reference levels are the same.

According to some non-limiting embodiments (such as the one shown in FIG. 8), the detection device 40 is provided with a plurality of sensors 41, each of which is designed to detect the level of powder material CP inside the transfer chamber TC substantially vertically below a respective passage area 30 and/or 31. The control unit 34 is designed to activate each drive unit 36 according to what has been detected by the sensor 41 located below the respective passage area 30 and/or 31. In particular, the control unit 34 is designed to allow the passage of powder material through a passage area 30 and/or through the adjacent passage area 31 when the corresponding sensor 41, i.e. the sensor 41 placed vertically below the area 30 and/or 31, does not detect the presence of powder material in the transfer chamber TC at its position, and to block the passage of powder material through a passage area 30 and/or through the adjacent passage area 31 when the corresponding sensor 41, i.e. the sensor 41 placed vertically below the zone 30 and/or 31, detects the presence of powder material in the transfer chamber TC at its position.

Each sensor 41 comprises (consists of), e.g., an optical or resistive, or capacitive, etc. detector. According to some specific non-limiting embodiments, the detection device 40 comprises (consists of) a row of sensors 41, only some of which are shown in FIG. 8, with e.g. a 10 mm pitch. In these cases, the operating device 32 comprises drive units 36 with e.g. a 10 mm pitch.

According to some non-limiting embodiments, the plant 1 comprises a printing device 42 (FIG. 1), which is designed to provide a graphic decoration over the compacted ceramic powder layer KP transported by the conveyor assembly 5 and is arranged at a printing station 43 (located upstream of the outlet station 7) along the given path (in particular, along the portion PB) downstream of the working station 4. The control unit 34 is designed to control the printing device 42 to provide a graphic decoration coordinated with the aforementioned reference distribution 35, in particular so that a graphic decoration of a particular colour is selectively shown by the powder material CA.

Advantageously but not necessarily, the plant 1 comprises a further application assembly 44 to at least partially cover the powder material CP with a layer of a further powder material. In particular, the application assembly 44 is arranged along the given path, more precisely along the portion PA, upstream of the working station 4 and upstream of the printing station 43.

Advantageously but not necessarily, the wall 10 comprises a deformable portion 45 to vary the cross sectional area of at least a part of the transfer chamber TC with respect to the direction B.

It has been experimentally observed that by varying the cross sectional area it is possible to reduce the risk of possible clogging in the transfer chamber TC and, in particular, it is surprisingly possible to vary the shape of the distribution of the powder materials CA and/or CB in the thickness of the layer of powder material CP conveyed by the conveyor assembly. In this way, it is possible to obtain a more natural effect even in the thickness of the ceramic articles T.

By way of example, FIGS. 3 and 4 show an embodiment of the machine 2 in two operative conformations. In the first (FIG. 3), the area of the section is reduced; in the second (FIG. 4), the area of the section is increased.

In particular, the machine 2, and more precisely the transfer chamber TC, comprises a moving unit 46, e.g. a mechanism connected to an electric motor or comprising a fluid-dynamic actuator to modify the deformable portion 45 so as to vary the area of the aforementioned cross section.

Advantageously but not necessarily, the wall 10, and more precisely, the deformable portion 45, comprises a first portion 47 (in particular, a strip), designed to rotate about an oscillation axis 48, crosswise to the direction A and, in particular, to the direction C, and at least a second portion 49 (in particular, a portion of the belt 13) designed to rotate about a substantially fixed oscillation axis 50, which is crosswise to the direction A and in particular to the direction C, to vary the area of the aforementioned cross section. In particular, the axes 48 and 50 are substantially parallel to each other. More particularly, they are crosswise to the direction B.

According to some non-limiting embodiments, the portions 47 and 49 are in contact with each other and are designed to slide one on the other while rotating (oscillating) about the axes 48 and 50, respectively.

According to some non-limiting embodiments, the moving unit 46 is designed to rotate the portion 49 about the axis 50.

Advantageously but not necessarily, the machine further comprises a thrust device (of a type per se known and not shown, e.g. a spring device) to push the portion 47 towards (against) the section 49, in particular to rotate/oscillate the portion 47 about the axis 48.

The wall 10 comprises at least one further portion 51, having at least one substantially fixed portion (more precisely, the portion 51 is substantially fixed) with respect to the axis 48 and to the axis 50. In particular, the portion 49 is at least partially interposed between the portions 47 and 51.

In some non-limiting cases, such as the one shown in FIGS. 3 and 4, the axis 50 is arranged at the portion 51, more precisely at one end of the portion 51.

According to some non-limiting embodiments, the portion 49 at least partially corresponds to the aforementioned first determined portion along which the movable surface 13′ extends.

According to some non-limiting and not shown embodiments, also the wall 11 has a deformable portion analogous to the deformable portion 45.

Advantageously but not necessarily, the feeding assembly 9 can modify over time the amount of powder material CP that it feeds to the conveyor assembly 5.

In particular, the machine 1 comprises a detection device 52 located downstream of the working station, which is designed to detect the density of the compacted powder layer KP. The control unit 34 is designed to control the feeding assembly 9 so as to vary over time the amount of powder material CP carried by the conveyor assembly 5 to the working station 4 based on what has been detected (the density of the layer of detected compacted ceramic powder KP) by the detection device 52.

In these cases, the operation of the machine is as described in the patent application with publication number WO 2017/216725 of the same applicant.

Advantageously but not necessarily, the conveyor assembly 5 comprises a conveyor belt 54, which extends from the inlet station 6 towards the working station 4 (substantially in the advancing direction A) and is configured to convey said powder material CP from the inlet station 6 towards the working station 4.

In particular, the feeding assembly 9, more precisely the transfer chamber TC, is configured to feed the powder material CP onto (in contact with) the conveyor belt 54, substantially extending in the direction A crosswise (substantially perpendicular) to the belt conveyor 54.

More particularly, the feeding assembly 9 and more precisely the transfer chamber TC, is configured to feed the powder material CP onto (in contact with) the conveyor belt 54, substantially extending in the direction A, mainly in the direction B, crosswise (substantially perpendicular) to the direction A.

In particular, the feeding assembly 9 comprises a dispensing unit 53 similar to the dispensing unit described in WO2017/216725 (therein identified with the number 21).

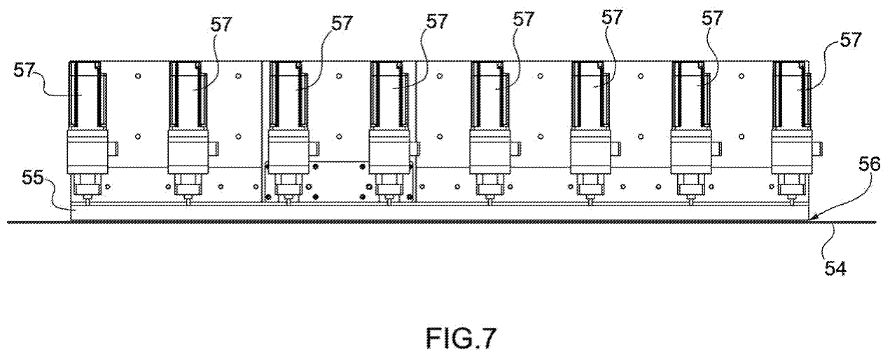

The dispensing unit 53 (substantially, a lower end of the feeding assembly 9 and of the transfer chamber TC) is designed to carry a layer of not compacted powder material CP on the conveyor belt 54 of the conveyor assembly 5 at the inlet station 6 and comprises a pen-shaped cross member 55 (FIGS. 3 to 7), which is crosswise to the advancing direction A, about which the belt 13 partially slides (by deforming) and which is arranged above the conveyor belt 54 to delimit an opening 56 between the belt 13 and the conveyor belt 54, whose height (distance between the cross member 55 and the conveyor belt 54) defines the thickness of the layer of powder material CP on the conveyor belt 54. In particular, in use, the layer of powder material CP passes through the opening 56.

In these cases, the feeding assembly 9, or more precisely the dispensing unit 53, comprises at least one actuator 57 to vary the height of the opening 56, i.e. the distance between the cross member 55 and the conveyor belt 54.

The actuator 57 can e.g. comprise (be) an electronically controlled hydraulic actuator and/or a brushless electric motor, more specifically a stepper motor.

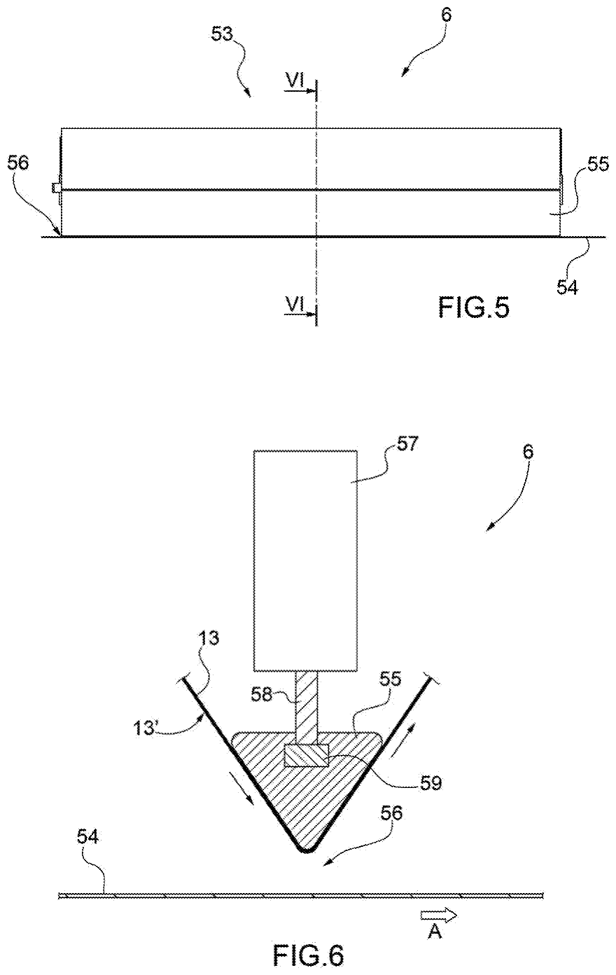

According to more specific but non-limiting embodiments (such as those shown in FIGS. 5 to 7), the feeding assembly 9, or more precisely the dispensing unit 53, comprises a plurality of actuators 57 arranged in succession crosswise to the advancing direction A. In particular, they are arranged along a crosswise, more precisely substantially perpendicular line with respect to the direction A and are operable (able to be operated) independently of one another so as to deform the cross member 55, more accurately described below, and therefore vary the height of the areas of the opening 56 in a differentiated manner.

In other words, the actuators 57 can be operated so that the distance between the cross member 55, in particular the belt 13, and the conveyor belt 54 is differently varied crosswise to the advancing direction A.

More precisely, the control unit 34 is designed to actuate the actuators 57 independently of each other so as to deform the cross member 55 and therefore vary the height of the areas of the opening 56 in a differentiated manner.

In particular, the cross member 55 comprises (is made of) an elastically deformable material, typically an elastomer.

According to some embodiments, it is provided a connecting arm 58 extending between each actuator 57 and the cross member 55. In particular, the arm 58 is connected to the cross member 55 by means of an insert 59 embedded in the cross member 55.

Advantageously but not necessarily, the conveyor assembly 5 is designed to transport (and, in use, transports) the powder material CP along the portion PA at a speed substantially equal to the speed at which the moving device 14 is designed to move (and, in use, moves) the movable surface 13′, more precisely the belt 13. More precisely, the conveyor belt 54 moves at a speed substantially equal to the one at which the belt 13 moves.

In particular (see FIG. 1), the machine 1 further comprises a cutting unit 60 for crosswise cutting the layer of compacted ceramic powder KP so as to obtain slabs (base articles) 61, each of which has a portion of the compacted ceramic powder layer KP. More particularly, the cutting unit 60 is arranged along the portion PB of the given path, between the working station 4 and the printing station 29. Slabs 61 comprise (consist of) compacted ceramic powder KP.

Advantageously but not necessarily, the cutting unit 60 comprises at least one cutting blade 62, which is designed to come into contact with the compacted ceramic powder layer KP to cut it crosswise with respect to the direction A.

According to some non-limiting embodiments, the cutting unit 60 further comprises at least two further blades 63, which are arranged on opposite sides of the portion PB and are designed to cut the compacted ceramic powder layer KP and define side edges of the slabs 61 that are substantially parallel to direction A, possibly subdividing the slab into two or more longitudinal portions. In some specific cases, the cutting unit 60 is like the one described in the patent application with publication number EP1415780.

In particular, the plant 1 comprises at least one firing kiln 64 for sintering the compacted powder layer KP of the slabs 61 so as to obtain the ceramic articles T. More in particular, the firing kiln 64 is arranged along the given path, more precisely along the portion PB, downstream of the printing station 43 and upstream of the outlet station 7.

According to some non-limiting embodiments, the plant 1 further comprises a dryer 65 arranged along the portion PB downstream of the working station 4 and upstream of the printing station 43.

In some cases, the feeding assembly 9 is designed to bring a layer of not compacted powder material CP on the conveyor assembly 5, in particular, on the conveyor belt 54; more particularly at the inlet station 6. The compacting device 3 is designed to exert on the ceramic powder layer CP a crosswise pressure, in particular normal with respect to the surface of the conveyor belt 54.

According to some non-limiting embodiments, downstream of the conveyor belt 54 the conveyor assembly 5 comprises a succession of transport rollers.

According to some non-limiting embodiments, in particular, the compacting device 3 comprises at least two compression rollers 67 arranged on opposite sides (one above and one below) of the conveyor belt 54 to exert pressure on the powder material CP to compact the powder material CP and obtain the compacted powder layer KP.

Although only two rollers 67 are shown in FIG. 1, according to some variants, it is also possible to provide a plurality of rollers 67 arranged above and below the conveyor belt 54, as described e.g. in the patent EP1641607B1, from which further details of the compacting device 3 can be deduced.

Advantageously (as in the embodiment shown in FIG. 1) but not necessarily, the compacting device 3 comprises a pressure belt 68, which converges towards the conveyor belt 54 in the advancing direction A. In this way, it is exerted a downwards pressure, which gradually increases in the direction A on the powder material CP in order to compact it.

According to specific non-limiting embodiments, such as the one shown in FIG. 1, the compacting device further comprises a contrast belt 68′ arranged on the opposite side of the conveyor belt 54 with respect to the pressure belt to cooperate with the conveyor belt 54 to provide an adequate response to the downwards force exerted by the pressure belt 68. In particular, the pressure belt 68 and the contrast belt 68′ are (mainly) made of metal (steel) so as not to be substantially deformed while pressure is exerted on the ceramic powder.

According to some not shown and non-limiting embodiments, the contrast belt 68′ and the conveyor belt 54 coincide. In these cases, the conveyor belt 54 is (mainly) made of metal (steel) and the contrast belt 68′ is absent.

Advantageously but not necessarily, the detection device 52 is arranged along the portion PB upstream of the firing kiln 64, in particular downstream of the dryer 65.

Advantageously but not necessarily, the printing device 42 is arranged along the portion PB upstream of the firing kiln 64, in particular downstream of the dryer 65; more particularly, downstream of the detection device 52.

According to some non-limiting embodiments, the transfer chamber TC, which extends vertically below the feeding devices 24 and 25, has a width of about 29-69 mm and a height of about 129-179 mm. Typically, the detection device 40 and therefore the sensors 42 are arranged at about 79-109 mm from the lower end of the transfer chamber TC. In accordance with possible embodiments, the outlet mouth located at the lower end of the transfer chamber TC has a height, depending on the need, of about 5-79 mm. In this way, the layer of powder material CP carried by the conveyor assembly 5 has a similar thickness of about 5-79 mm.

In actual use, the powder material is supplied by the feeding device 24 and/or 25 based on what suggested by the intersection between the virtual reference front RP and the reference distribution 35 by actuating specific drive units 36 to drain the powder material from specific passage areas 30 and/or 31 when the specific respective sensors 41 indicate a level of powder material lower than a reference threshold level in the transfer chamber TC at the specific sensors 41.

In accordance with an aspect of the present invention, it is further provided a method for compacting a powder material CP comprising ceramic powder. The method comprises at least one compacting step, during which the powder material CP is compacted at a working station 4 so as to obtain a layer of compacted powder material KP; a conveying step, during which the powder material CP is (substantially continuously) conveyed by means of a conveyor assembly 5 along a first portion PA of a given path from an inlet station 6 to the working station 4 and the layer of compacted powder material KP is (substantially continuously) conveyed from the working station 4 along a second portion PB of the given path; and a feeding step, during which the powder material CP is fed to the conveyor assembly 5 at the inlet station 6 by means of a feeding assembly 9. In particular, the conveying and feeding steps are at least partially simultaneous.

The feeding assembly 9 comprises a transfer chamber TC, which, during the feeding step, holds and transfers the powder material CP, in particular, along a transfer path TP; in particular, in a transfer direction B.

The transfer chamber TC has at least one wall 10, which is crosswise to the advancing direction A.

Advantageously but not necessarily, the conveyor assembly 5 comprises a conveyor belt 54, which extends from the inlet station 6 substantially in the advancing direction A and, during the conveying step, conveys the powder material CP from the inlet station 6 towards the working station 4, more precisely along the first portion PA from the inlet station 6 to the working station 4.

In particular, during the conveying step, the feeding assembly 9, more precisely the transfer chamber TC, feeds the powder material CP onto the conveyor belt 54, extending substantially in the direction A crosswise (substantially perpendicularly) to the conveyor belt 54.

More particularly, during the conveying step, the feeding assembly 9, more precisely the transfer chamber TC, feeds the powder material CP onto the conveyor belt 54 (extending substantially in the direction A) mainly in the direction B, crosswise (substantially perpendicular) to the direction A.

Advantageously but not necessarily, the transfer chamber TC also comprises at least one advancing assembly 12, which has a movable surface 13′ arranged at the wall 10. During the feeding step, while the powder material CP is fed to the conveyor assembly 5, more precisely while the powder material CP is placed on the conveyor assembly 5, even more precisely, on the conveyor belt 54, the movable surface 13′ moves (slides) crosswise to the advancing direction A towards the inlet station 6 and the conveyor assembly 5.

According to some non-limiting embodiments, the feeding assembly 9 comprises a feeding device 24, which feeds (in particular, during the feeding step) a powder material CA of a first type to the transfer chamber TC; a feeding device 25, which feeds (in particular, during the feeding step) a powder material CB of a second type to the transfer chamber TC; and an operating device 32, which selectively regulates (in particular, during the feeding step) the passage of the powder material to the transfer chamber TC from the feeding device 24 and from the second feeding device 25.

Advantageously but not necessarily, the transfer chamber TC comprises at least one further wall 11 crosswise to the advancing direction A and facing the wall 10. The advancing assembly 12 comprises a further movable surface 17′ arranged at the second wall 10. During the feeding step, while the powder material CP is fed to the conveyor assembly 5; more precisely, while the powder material CP is placed on the conveyor assembly 5, even more precisely on the conveyor belt 54), the movable surface 17′ moves crosswise to the direction A towards the inlet station 6 and the feeding assembly 9.

According to some non-limiting embodiments, during the feeding step, the movable surface 13′ moves in a moving direction C crosswise to the advancing direction A towards the inlet station 6 and the conveyor assembly 5. In particular, the method comprises an adjustment step, during which the position of the movable surface 13′ is adjusted in a direction crosswise to the advancing direction A and to the moving direction C. More particularly, the adjustment step comprises a detection sub-step, during which the position of the movable surface 13′ is detected (crosswise to the direction C), and a displacement sub-step, during which the movable surface 13′ is moved in the direction crosswise to the advancing direction A and to the moving direction C according to what has been detected during the detection step.

In some non-limiting cases, also the position of the movable surface 17′ is adjusted during the adjustment step, analogously to what described above with regard to the movable surface 13′.

In particular, the movable surface 13′ is the surface of a belt 13 facing the inside of the transfer chamber TC.

Advantageously but not necessarily, the method further comprises a variation step, during which the area of a cross section of at least a part of the transfer chamber TC is modified, in particular by modifying the shape of a deformable portion 45 of the wall 10.

According to some non-limiting embodiments, the method is implemented by a machine 2 as described above.

Advantageously but not necessarily, during the variation step the area of the mentioned cross section is modified by rotating the portion 47 about the oscillation axis 48, crosswise to the direction A and substantially fixed and the portion 49 about the oscillation axis 49, crosswise to the direction A and substantially fixed.

1-18. (canceled)

19. A machine for compacting a powder material comprising ceramic powder; the machine comprises a compacting device, which is arranged at a working station and is designed to compact the powder material so as to obtain a layer of compacted powder material; a conveyor assembly to transport the powder material along a first portion of a given path in an advancing direction from an inlet station to the working station and the layer of compacted powder material from the working station along a second portion of the given path; and a feeding assembly, which is designed to feed the powder material to the conveyor assembly at the inlet station and comprises a transfer chamber, which is designed to hold and transfer the powder material, in particular along a transfer path;
wherein the transfer chamber has a first wall, which is crosswise to the advancing direction, and at least a second wall, which is crosswise to the advancing direction, faces the first wall and is arranged upstream of the first wall relative to the advancing direction;
the feeding assembly comprises at least an advancing assembly, which in turn comprises at least a first belt at least partially arranged at the first wall and a first moving device to move the first belt towards the conveyor assembly;
the advancing assembly further comprises at least a second belt, at least partially arranged at the second wall, and a second moving device to move the second belt towards the conveyor assembly; and
the first moving device comprises a first adjusting assembly to adjust the crosswise position of the first belt; in particular, the second moving device comprises a second adjusting assembly to adjust the crosswise position of the second belt.

20. A machine according to claim 19, wherein the feeding assembly comprises a first feeding device, which is designed to hold and feed a powder material of a first type to the transfer chamber; a second feeding device, which is designed to hold and feed a powder material of a second type to the transfer chamber; and an operating device, which is designed to adjust the passage of the powder material of the first type to the transfer chamber from the first feeding device and the powder material of the second type from the second feeding device.

21. A machine according to claim 19, wherein the first belt defines at least a portion of the first wall; in particular, at least one between the first wall and the second wall is substantially perpendicular to the advancing direction; in particular, the transfer chamber is designed to transfer the powder material mainly in a transfer direction, which is substantially perpendicular to the advancing direction.

22. A machine according to claim 19, wherein the first moving device is designed to move the first belt along at least a first portion of the transfer path; the second moving device is designed to move the second belt along at least a second portion of the transfer path; the first portion and the second portion of the transfer path at least partially coincide; in particular, the second belt defines at least a portion of the second wall.

23. A machine according to claim 19, wherein the first belt comprises a polymer material; the transfer chamber further comprises side walls, which laterally delimit the transfer chamber and are crosswise to the first wall and to the second wall; in particular, the second belt comprises a polymer material; in particular, the side walls are substantially parallel to the advancing direction.

24. A machine according to claim 19, wherein the first moving device comprises at least a first motor-driven pulley; in particular, the second moving device comprises at least a second motor-driven pulley.

25. A machine according to claim 19, wherein the first moving device comprises at least a first tensioner pulley; in particular, the second moving device comprises at least a first tensioner pulley.

26. A machine according to claim 19, wherein the conveyor assembly comprises a conveyor belt, which extends from the inlet station to the working station and is configured to convey said powder material from the inlet station to the working station;
the feeding assembly is configured to feed the powder material onto the conveyor belt, crosswise to the conveyor belt.

27. A machine according to claim 19, wherein the first moving device is designed to move the first belt in a moving direction, which is crosswise to the advancing direction; the first moving device comprises at least a first motor-driven pulley, about which the first belt is partially wound and which has a respective axis of rotation, which is crosswise to the advancing direction;
the adjusting assembly comprises an adjusting roller, which is in contact with the first belt and has a respective further axis of rotation and a positioning device to rotate the adjusting roller so that the further axis of rotation changes its inclination relative to the moving direction.

28. A machine according to claim 19, wherein the first wall comprises a deformable portion in order to change the area of a cross section of at least part of the transfer chamber; in particular, the feeding assembly comprises a moving unit to change the shape of the deformable portion so as to change the area of said cross section.

29. A plant for the production of ceramic articles; the plant comprises at least a machine for compacting a ceramic powder material according to claim 19; a cutting assembly to crosswise cut the layer of compacted ceramic powder so as to obtain base articles, each having a portion of the layer of compacted ceramic powder;
and at least a firing kiln to sinter the compacted ceramic powder of the base articles so as to obtain the ceramic articles.

30. A method for compacting a powder material comprising ceramic powder; the method comprises at least a compacting step, during which the powder material is compacted at a working station so as to obtain a layer of compacted powder material; a conveying step, during which the powder material is conveyed, by means of a conveyor assembly, along a first portion of a given path from an inlet station to the working station and the layer of compacted powder material is conveyed out of the working station along a second portion of the given path; and a feeding step, during which the powder material is fed to the conveyor assembly at the inlet station by means of a feeding assembly; in particular, the conveying step and the feeding step are at least partially simultaneous;
the feeding assembly comprises a transfer chamber, which, during the feeding step, holds and transfers the powder material;
wherein the transfer chamber has at least a first wall, which is crosswise to the advancing direction, and at least a second wall, which is crosswise to the advancing direction, faces the first wall and is arranged upstream of the first wall relative to the advancing direction; the feeding assembly comprises at least an advancing assembly, which comprises a first movable surface arranged at the first wall and a second movable surface arranged at the second wall;
during the feeding step, the first movable surface and the second movable surface move crosswise to the advancing direction towards the conveyor assembly;
during the feeding step, the first movable surface moves in a moving direction crosswise to the advancing direction towards the conveyor assembly; the method comprises an adjusting step, during which the position of the first movable surface is adjusted in a direction crosswise to the advancing direction and to the moving direction.

31. A method according to claim 30, wherein the feeding assembly comprises a first feeding device, which feeds , during the feeding step, a powder material of a first type to the transfer chamber; a second feeding device, which feeds, during the feeding step, a powder material of a second type to the transfer chamber; and an operating device, which controls, during the feeding step, the passage of the powder material to the transfer chamber from the first feeding device and from the second feeding device.

32. A method according to claim 30, wherein the adjusting step comprises a detection sub-step, during which the position of the first movable surface is detected crosswise to the moving direction, and a displacement sub-step, during which the first movable surface is displaced in the direction crosswise to the advancing direction and to the moving direction based on the data detected during the detection step.

33. A method according to claim 30, wherein the transfer chamber transfers the powder material mainly in a transfer direction, which is substantially perpendicular to the advancing direction; in particular, at least one between the first wall and the second wall is substantially perpendicular to the advancing direction.

34. A method according to claim 30, wherein the transfer chamber further comprises side walls, which laterally delimit the transfer chamber and are crosswise to the first and to the second wall; in particular, the side walls are substantially parallel to the advancing direction.

35. A method according to claim 30, wherein the conveyor assembly comprises a conveyor belt, which extends from the inlet station substantially in the advancing direction and, during the conveying step, conveys the powder material from the inlet station to the working station;
during the conveying step, the feeding assembly feeds the powder material onto the conveyor belt crosswise to the conveyor belt.
